(19) United States
(12) Patent Application Publication
(10) Pub. No.: US 2025/0222901 A1
(43) Pub. Date: Jul. 10, 2025

(54) VEHICLE WASHER FLUID SYSTEMS WITH SECONDARY WASHER FLUID RESERVOIRS

(71) Applicant: FORD GLOBAL TECHNOLOGIES, LLC, Dearborn, MI (US)

(72) Inventors: Michael Robertson, West Bloomfield, MI (US); Venkatesh Krishnan, Canton, MI (US)

(21) Appl. No.: 18/404,106

(22) Filed: Jan. 4, 2024

(51) Int. Cl. B60S 1/50; B60S 1/48

(52) U.S. Cl. CPC B60S 1/50; B60S 1/481

(57) ABSTRACT

Washer fluid systems are provided for motor vehicles. The washer fluid systems may supply a washer fluid for cleaning various front and rear mounted components (e.g., cameras, sensors, etc.) of the vehicle. An exemplary washer fluid system may include a first washer fluid reservoir for providing the washer fluid to components located within a front zone of the vehicle, and a second washer fluid reservoir for providing the washer fluid to components located within a rear zone of the vehicle. The rear zone is fluidly isolated from the front zone. The second washer fluid reservoir may be mounted within a cargo bed of the vehicle.

### TECHNICAL FIELD

This disclosure relates generally to motor vehicles, and more particularly to vehicle washer fluid systems that include a secondary washer fluid reservoir for supplying washer fluid to rear mounted vehicle component of a vehicle.

### BACKGROUND

Many vehicles include washer fluid systems for delivering a washer fluid to clean various areas of the vehicles. For example, the washer fluid system can supply washer fluid for cleaning windows, cameras, and/or sensors of the vehicle.

### SUMMARY

A motor vehicle according to an exemplary aspect of the present disclosure includes, among other things, a cargo bed, and a washer fluid reservoir mounted within the cargo bed.

In a further non-limiting embodiment of the foregoing motor vehicle, the washer fluid reservoir is mounted within a side wall of the cargo bed.

In a further non-limiting embodiment of either of the foregoing motor vehicles, the washer fluid reservoir is mounted between an inner panel and an outer panel of the side wall at a location between a wheel well and a rear-most pillar of the cargo bed.

In a further non-limiting embodiment of any of the foregoing motor vehicles, the washer fluid reservoir includes a mounting flange, a reservoir housing, and a closeout panel.

In a further non-limiting embodiment of any of the foregoing motor vehicles, the mounting flange is mounted to a panel of a side wall of the cargo bed.

In a further non-limiting embodiment of any of the foregoing motor vehicles, a first portion of the reservoir housing extends above a floor of the cargo bed, and a second portion of the reservoir housing extends below the floor.

In a further non-limiting embodiment of any of the foregoing motor vehicles, the closeout panel is attached to the reservoir housing to establish an interior volume for storing a washer fluid.

In a further non-limiting embodiment of any of the foregoing motor vehicles, a pump is fluidly connected to the interior volume and is operable to deliver the washer fluid from the washer fluid reservoir to a camera or a sensor that is mounted within the cargo bed.

In a further non-limiting embodiment of any of the foregoing motor vehicles, a fluid level sensor extends into the interior volume. The fluid level sensor is configured to sense when a fluid level of the washer fluid falls below a threshold value.

In a further non-limiting embodiment of any of the foregoing motor vehicles, the washer fluid reservoir includes a fill neck recessed within a pocket section of the washer fluid reservoir. The pocket section extends between the mounting flange and an upper front surface of the reservoir housing.

In a further non-limiting embodiment of any of the foregoing motor vehicles, a fill cap is removably connected to the fill neck.

A washer fluid system for a motor vehicle according to another exemplary aspect of the present disclosure includes, among other things, a front zone including a first washer fluid reservoir configured for providing a washer fluid to a first camera or a first sensor located within the front zone. A rear zone includes a second washer fluid reservoir configured for providing the washer fluid to a second camera or a second sensor located within the rear zone. The rear zone is fluidly isolated from the front zone.

In a further non-limiting embodiment of the foregoing washer fluid system, the rear zone encompasses a cargo bed of the motor vehicle.

In a further non-limiting embodiment of either of the foregoing washer fluid systems, the second washer fluid reservoir is mounted within a side wall of the cargo bed.

In a further non-limiting embodiment of any of the foregoing washer fluid systems, the second washer fluid reservoir is mounted between an inner panel and an outer panel of the side wall at a location between a wheel well and a rear-most pillar of the cargo bed.

In a further non-limiting embodiment of any of the foregoing washer fluid systems, the second camera or the second sensor is mounted within the cargo bed.

In a further non-limiting embodiment of any of the foregoing washer fluid systems, a first hose is connected between the first washer fluid reservoir and the first camera or the first sensor. A second, different hose is connected between the second washer fluid reservoir and the second camera or the second sensor.

In a further non-limiting embodiment of any of the foregoing washer fluid systems, the second washer fluid reservoir includes a mounting flange, a reservoir housing, and a closeout panel.

In a further non-limiting embodiment of any of the foregoing washer fluid systems, the closeout panel is attached to the reservoir housing to establish an interior volume for storing a portion of the washer fluid.

In a further non-limiting embodiment of any of the foregoing washer fluid systems, the second washer fluid reservoir includes a pump and a fluid level sensor.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a motor vehicle equipped with a washer fluid system.

FIG. 2 is a front perspective view of an exemplary secondary washer fluid reservoir of a vehicle washer fluid system.

FIG. 3 is a rear perspective view of the secondary washer fluid reservoir of FIG. 2.

FIG. 4 is an exploded view of the secondary washer fluid reservoir of FIG. 2.

FIG. 5 illustrates the secondary washer fluid reservoir of FIG. 2 with a closeout panel removed.

FIG. 6 schematically illustrates adding a washer fluid to an interior volume of a secondary washer fluid reservoir.

FIG. 7 schematically illustrates delivering washer fluid to multiple cargo bed mounted cameras simultaneously.

FIG. 8 schematically illustrates delivering washer fluid to multiple cargo bed mounted cameras in groups.

FIG. 9 schematically illustrates delivering washer fluid to multiple cargo bed mounted cameras individually.

FIG. 10 illustrates select portions of a cargo bed of a motor vehicle.

FIG. 11 is a blown up view of select portions of the cargo bed of FIG. 10.

FIG. 12 illustrates the cargo bed of FIG. 11 with portions removed for better illustrating a secondary washer fluid reservoir of a vehicle washer fluid system.

FIG. 13 illustrates aspects of an automated vehicle washer fluid system.

FIG. 14 illustrates aspects of a manual vehicle washer fluid system.

### DETAILED DESCRIPTION

This disclosure describes washer fluid systems for motor vehicles. The washer fluid systems may supply a washer fluid for cleaning various front and rear mounted components (e.g., cameras, sensors, etc.) of the vehicle. An exemplary washer fluid system may include a first washer fluid reservoir for providing the washer fluid to components located within a front zone of the vehicle, and a second washer fluid reservoir for providing the washer fluid to components located within a rear zone of the vehicle. The rear zone is fluidly isolated from the front zone. The second washer fluid reservoir may be mounted within a cargo bed of the vehicle. These and other features of this disclosure are discussed in greater detail in the following paragraphs of this detailed description.

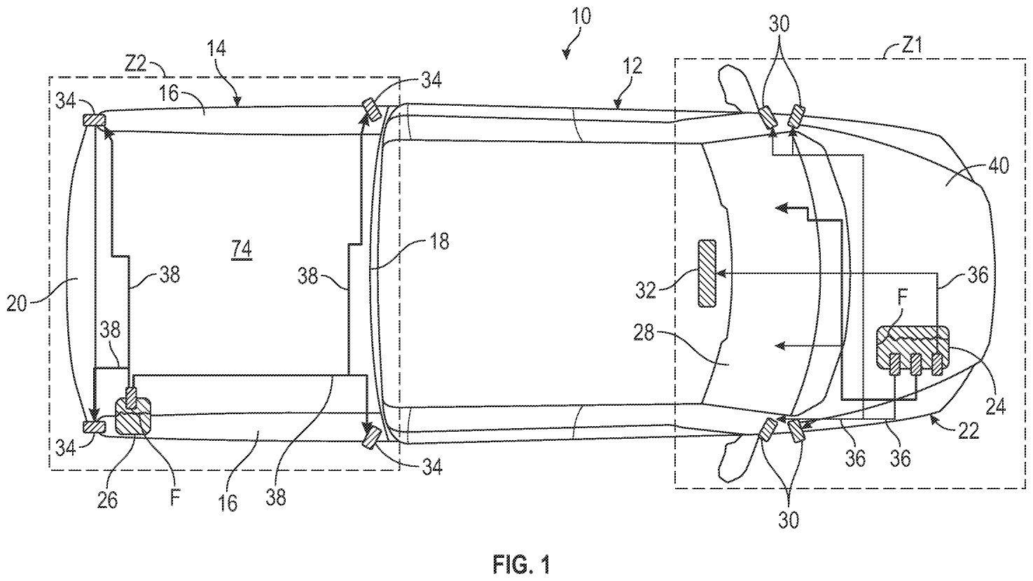

FIG. 1 schematically illustrates a motor vehicle 10 that includes a passenger cabin 12 and a cargo bed 14 located rearward of the passenger cabin 12. The vehicle 10 could be a conventional, internal combustion engine powered vehicle, a hybrid or plug-in hybrid vehicle, a battery electric vehicle, an autonomous vehicle (i.e., a driverless vehicle), etc.

In an embodiment, the vehicle 10 is a pickup truck, and therefore the cargo bed 14 establishes a rear cargo space of the pickup truck. The cargo bed 14 may generally be defined by side walls 16, a front wall 18 that is adjacent to the passenger cabin 12, a tailgate 20 that acts as a rear wall of the cargo bed 14 when closed, and a floor 74 that acts as a base of the cargo bed 14. However, other vehicle configurations are also contemplated within the scope of this disclosure.

Although a specific component relationship is illustrated in the figures of this disclosure, the illustrations are not intended to limit this disclosure. The placement and orientation of the various components of the depicted vehicles are shown schematically and could vary within the scope of this disclosure. In addition, the various figures accompanying this disclosure are not necessarily drawn to scale, and some features may be exaggerated or minimized to emphasize certain details of a particular component or system.

The vehicle 10 may include a washer fluid system 22 for storing and delivering a washer fluid F that can be used to clean various areas of the vehicle 10. The washer fluid system 22 may include a primary or first washer fluid reservoir 24 and a secondary or second washer fluid reservoir 26. The first washer fluid reservoir 24 may be part of a front zone Z1 of the washer fluid system 22, and the second washer fluid reservoir 26 may be part of a rear zone Z2 of the washer fluid system 22.

The front zone Z1 and the rear zone Z2 may be fluidly isolated from one another. Accordingly, the washer fluid F stored and delivered within each respective zone is separate and distinct from the other zone.

The first washer fluid reservoir 24 may be mounted beneath a hood 40 of the vehicle 10 (e.g., within an engine compartment or frunk of the vehicle), and, as discussed in greater detail below, the second washer fluid reservoir 26 may be mounted within the cargo bed 14 of the vehicle 10. In an embodiment, the second washer fluid reservoir 26 is easily accessible by a user, such as for adding washer fluid F, when the tailgate 20 (or a door subassembly of the tailgate 20) is moved to an open position.

In an embodiment, the second washer fluid reservoir 26 is smaller than the first washer fluid reservoir 24. The second washer fluid reservoir 26 may thus include a smaller storage capacity for storing washer fluid F compared to the first washer fluid reservoir 24.

The washer fluid system 22 can draw washer fluid F from the first washer fluid reservoir 24 for cleaning areas located within the front zone Z1 of the vehicle 10. For example, the first washer fluid reservoir 24 may be equipped to supply washer fluid F for cleaning a windshield 28, one or more cameras 30, and one or more sensors 32 (e.g., LIDAR) that are mounted to the vehicle 10 and located within the front zone Z1. In an embodiment, the cameras 30 and the sensors 32 are part of an advanced driver assistance system (ADAS) for monitoring the environment in and around the vehicle 10. Notably, the type, total number, and mounting location of each the cameras 30 and the sensors 32 are exemplary only and thus not intended to limit this disclosure.

The washer fluid system 22 can draw an additional amount of washer fluid F from the second washer fluid reservoir 24 for cleaning areas located within the rear zone Z2 of the vehicle 10. For example, the second washer fluid reservoir 26 may be equipped to supply washer fluid F for cleaning one or more cameras 34 that are mounted within the cargo bed 14 and thus are located within the rear zone Z2. In an embodiment, the cameras 34 are part of the ADAS of the vehicle 10. Notably, the type, total number, and mounting location of each the cameras 34 provided on the cargo bed 14 are exemplary only and thus not intended to limit this disclosure. Moreover, various sensors could alternatively or additionally be mounted within the cargo bed 14 and could be cleaned using washer fluid F from the second washer fluid reservoir 26.

Hoses 36 may connect between the first washer fluid reservoir 24 and each of the windshield 28, the cameras 30, and the sensors 32 for delivering the washer fluid F from the first washer fluid reservoir 24 to desired areas of the front zone Z1, and additional hoses 38 may connect between the second washer fluid reservoir 26 and the cameras 34 for delivering the washer fluid F from the second washer fluid reservoir 26 to the cameras 34 of the rear zone Z2. Although not shown, the hoses 36, 38 could include washer nozzles for directing pressurized washer fluid F onto the surfaces that require cleaning. Because the front zone Z1 and the rear zone Z2 are fluidly isolated from one another, the washer fluid system 22 does not require routing hoses from the front zone Z1 to the rear zone Z2 or vice versa.

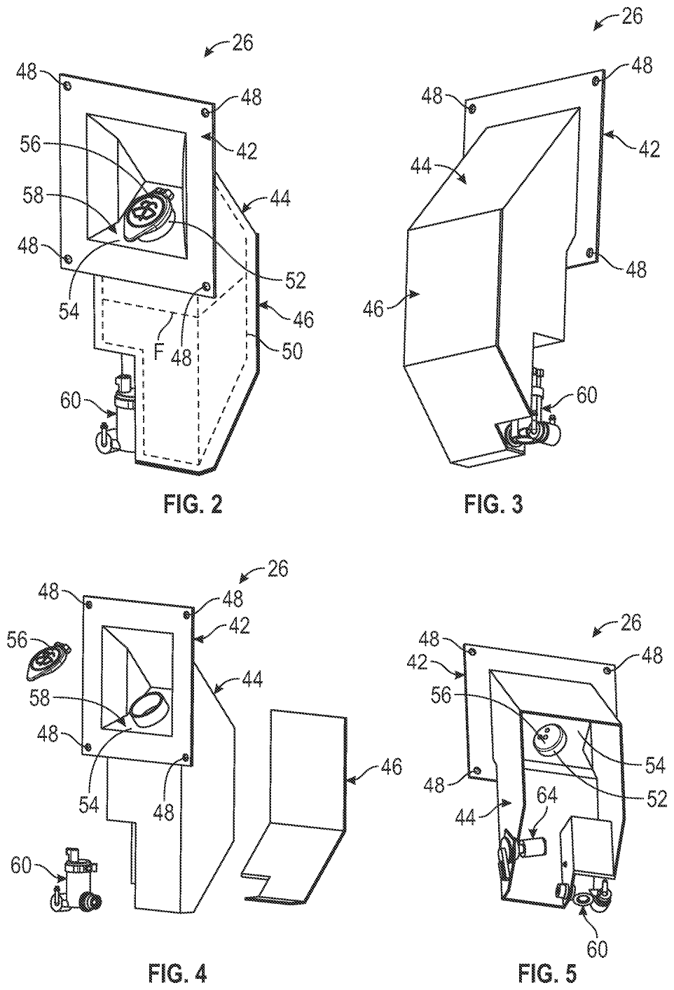

FIGS. 2, 3, 4, and 5 illustrate additional details associated with the second washer fluid reservoir 26 of the washer fluid system 22 of FIG. 1. The second washer fluid reservoir 26 may include a mounting flange 42, a reservoir housing 44, and a closeout panel 46. The mounting flange 42 may include multiple openings 48 that can each receive a fastener for mounting the second washer fluid reservoir 26 relative to the cargo bed 14 of the vehicle 10.

The reservoir housing 44 may extend downwardly in a direction away from the mounting flange 42. The closeout panel 46 may be attached (e.g., welded, adhered, mechanically fastened, etc.) to a rear side of the reservoir housing 44 to establish an interior volume 50 for storing the washer fluid F. In an embodiment, the interior volume 50 is sized to hold one or more gallons of the washer fluid F. However, the interior volume 50 could be sized to accommodate any volume of the washer fluid F.

A fill neck 52 opens into the interior volume 50. The fill neck 52 may be recessed within a pocket section 58 of the second washer fluid reservoir 26 that extends between the mounting flange 42 and an upper front surface 54 of the reservoir housing 44. The fill neck 52 may protrude outwardly from the upper front surface 54.

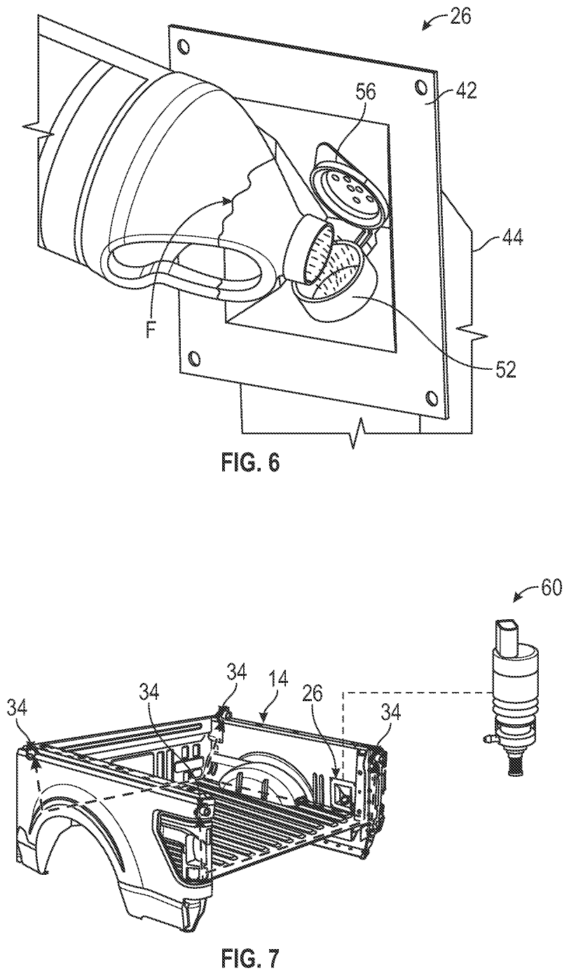

A fill cap 56 may be removably connected to the fill neck 52. The fill cap 56 may be periodically removed from the fill neck 52 to allow a user to add washer fluid F to the interior volume 50 (schematically shown in FIG. 6).

The second washer fluid reservoir 26 may additionally include one or more pumps 60. Each provided pump 60 is fluidly connected to the interior volume 50 and may be operable to deliver washer fluid F from the second washer fluid reservoir 26 to one or more of the cameras 34 (and/or other sensors) of the rear zone Z2.

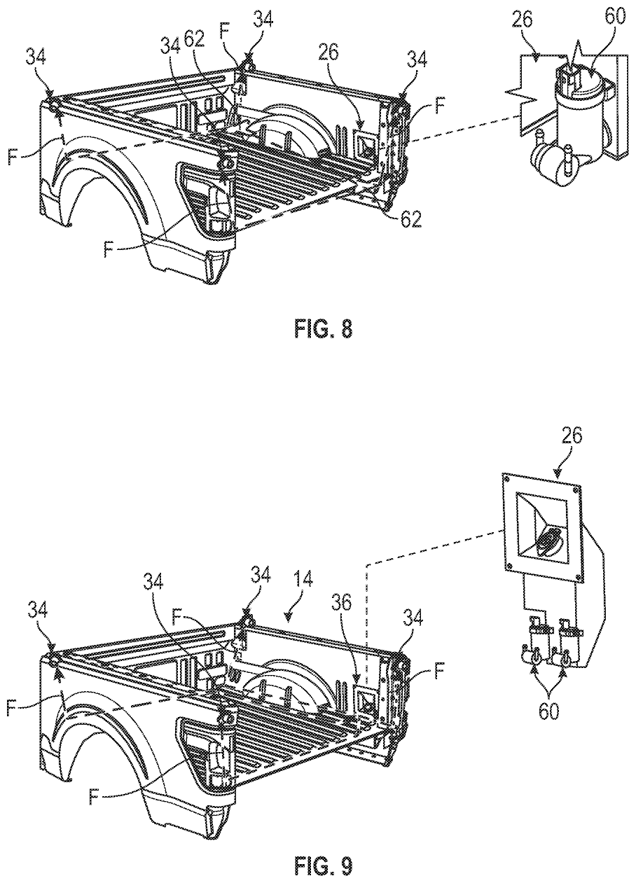

In an embodiment, the pump 60 of the second washer fluid reservoir 26 is a single outlet high pressure pump configured to deliver washer fluid F to each of the cameras 34 simultaneously (see FIG. 7). In another embodiment, the pump 60 of the second washer fluid reservoir 26 is a dual outlet high pressure pump configured to deliver washer fluid F to the cameras 34 in pairs by incorporating a fluid splitter 62 within the hoses 38 (see FIG. 8). In yet another embodiment, the second washer fluid reservoir 26 may include two dual outlet high pressure pumps 60 for delivering washer fluid F to each of the cameras 34 individually (see FIG. 9). It should be understood that alternate pump and hose routings are contemplated within the scope of this disclosure based on the desired cleaning configuration, number of cameras/sensors, etc.

The second washer fluid reservoir 26 may additionally include a fluid level sensor 64 (see FIG. 5). The fluid level sensor 64 may extend inside through the reservoir housing 44 and into the interior volume 50 for sensing when a fluid level of the washer fluid F contained within the interior volume 50 falls below a threshold value.

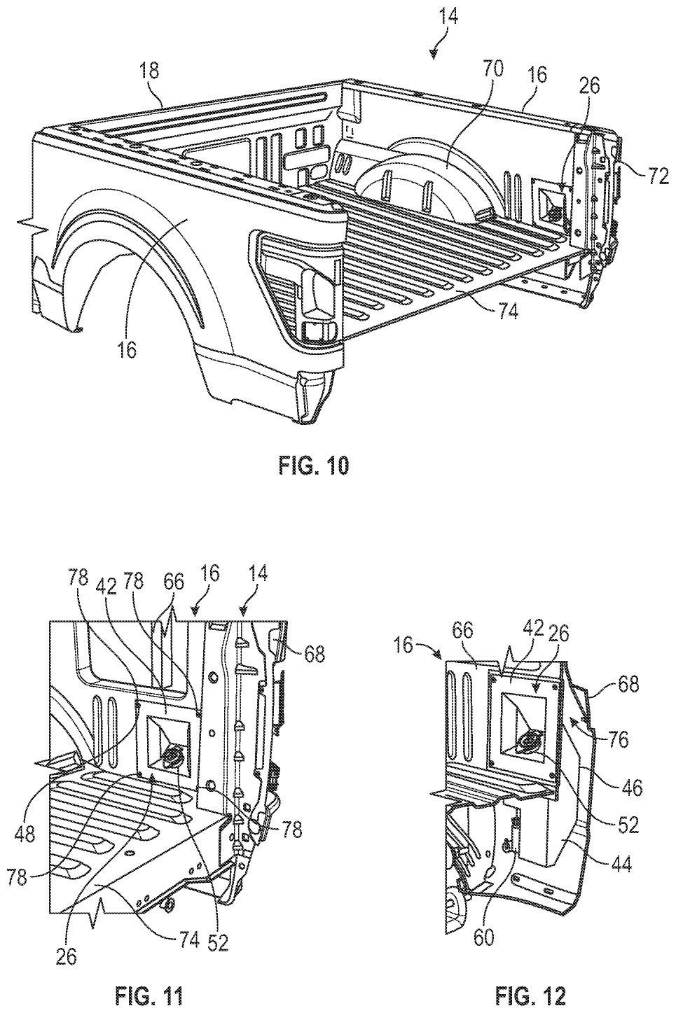

Referring now to FIGS. 10, 11, and 12, with continued reference to FIGS. 1-9, the second washer fluid reservoir 26 may be mounted within one of the side walls 16 of the cargo bed 14 of the vehicle 10. The second washer fluid reservoir 26 may be mounted between an inner panel 66 and an outer panel 68 of the side wall 16 at a location between a wheel well 70 and a rear-most pillar 72 of the cargo bed 14. The second washer fluid reservoir 26 is therefore at least partially located within an internal cavity 76 of the side wall 16. In an embodiment, the second washer fluid reservoir 26 is sized and shaped to occupy the same space typically occupied by cargo bed storage compartments that are commonly provided within many pickup truck cargo beds.

A portion of the reservoir housing 44 may extend vertically below a floor 74 of the cargo bed 14 in the mounted position of the second washer fluid reservoir 26. In an embodiment, the fill neck 52 of the second washer fluid reservoir 26 is located vertically above the floor 74, and the pump 60 is located vertically below the floor 74.

Vertical and horizontal, for purposes of this disclosure, are with reference to ground in an ordinary orientation of the vehicle 10 during operation.

The mounting flange 42 of the second washer fluid reservoir 26 may be mounted directly to the inner panel 66 of the side wall 16. For example, fasteners 78 may be inserted through the openings 48 for mounting the second washer fluid reservoir 26 relative to the side wall 16 of the cargo bed 14.

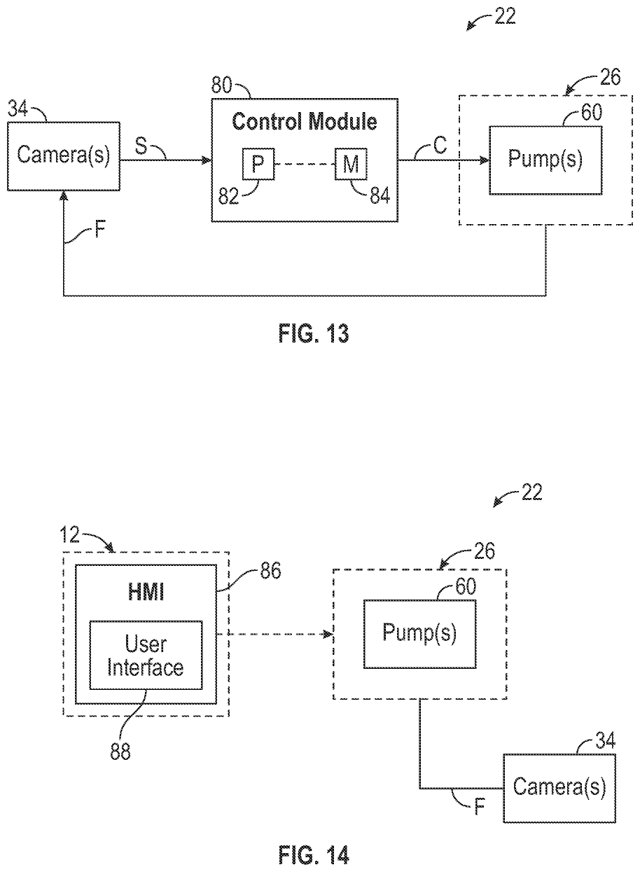

Referring now to FIG. 13, with continued refence to FIGS. 1-12, the one or more cameras 34 (and/or sensors) and the one or more pumps 60 of the rear zone Z2 of the washer fluid system 22 may be operably coupled to a control module 80. For example, these components may be interconnected and in electronic communication with one another over one or more communication buses. The communication buses may be wired communication buses such as a controller area network (CAN) bus, or wireless communication buses such as Wi-Fi, Bluetooth®, Ultra-Wide Band (UWB), etc. Although not specifically shown, the subcomponents of the front zone Z1 could also be operably connected to and controlled by the control module 80 or another control module.

The control module 80 may include both hardware and software and could be part of an overall vehicle control system, such as a vehicle system controller (VSC), or could alternatively be a stand-alone controller separate from the VSC. In an embodiment, the control module 80 is programmed with executable instructions for interfacing with and commanding operation of various components of the washer fluid system 22 as part of a strategy for automating the cleaning of the cameras for maintaining ADAS capability.

The control module 80 may include a processor 82 and non-transitory memory 84 for executing various control strategies and modes associated with the washer fluid system 22. The processor 82 may be a custom made or a commercially available processor, a central processing unit (CPU), or generally any device for executing software instructions. The memory 84 can include any one or combination of volatile memory elements and/or nonvolatile memory elements. The processor 82 may be operably coupled to the memory 84 and may be configured to execute one or more programs stored in the memory 84 based on various inputs received from other devices associated with the washer fluid system 22.

In an embodiment, the control module 80 may be programmed to selectively command the one or more pumps 60 to deliver washer fluid F from the second washer fluid reservoir 26 to the one or more cameras 34 for cleaning. For example, the control module 80 may be programmed to send a command signal C to the pumps 60 to cause the pumps 60 to deliver the washer fluid F to the cameras 34 in response to receiving a signal S from the one or more cameras 34 indicating that the cameras 34 require cleaning. The cameras 34 may each include integrated sensors for detecting a level of dirt build-up on a lens of the camera 34, for example.

Alternatively, as shown in FIG. 14, the washer fluid system 22 may include a human machine interface (HMI) 86 located within the passenger cabin 12 of the vehicle 10 and may include various user interfaces for displaying information to the vehicle occupants and for allowing the vehicle occupants to enter information into the HMI 86. The vehicle occupants may interact with the user interfaces via touch screens, tactile buttons, audible speech, speech synthesis, gesture recognition, etc. In an embodiment, the HMI 86 is part of an in-dash infotainment system of the vehicle 10. However, other configurations are further contemplated within the scope of this disclosure.

The HMI 86 may include one or more user interfaces 88 specifically dedicated to functionality associated with the washer fluid system 22. The one or more user interfaces 88 may allow the user to manually command actuation of the pump(s) 60 for delivering the washer fluid F to the one or more cameras 34 for cleaning.

The vehicle washer fluid systems of this disclosure may include a secondary washer fluid reservoir for directing washer fluid to cargo bed mounted cameras and/or sensors. Among other benefits, the secondary washer fluid reservoir eliminates the need to rout lengthy hoses from the front of the vehicle to the rear of the vehicle, thereby substantially eliminating fluid pressure loss over the hose lengths, allows for a reduction in size of the primary washer fluid reservoir, and provides the ability to clean the cargo bed mounted cameras and/or sensors either individually or in groups.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A motor vehicle, comprising:
a cargo bed; and
a washer fluid reservoir mounted within the cargo bed.

2. The motor vehicle as recited in claim 1, wherein the washer fluid reservoir is mounted within a side wall of the cargo bed.

3. The motor vehicle as recited in claim 2, wherein the washer fluid reservoir is mounted between an inner panel and an outer panel of the side wall at a location between a wheel well and a rear-most pillar of the cargo bed.

4. The motor vehicle as recited in claim 1, wherein the washer fluid reservoir includes a mounting flange, a reservoir housing, and a closeout panel.

5. The motor vehicle as recited in claim 4, wherein the mounting flange is mounted to a panel of a side wall of the cargo bed.

6. The motor vehicle as recited in claim 4, wherein a first portion of the reservoir housing extends above a floor of the cargo bed, and a second portion of the reservoir housing extends below the floor.

7. The motor vehicle as recited in claim 4, wherein the closeout panel is attached to the reservoir housing to establish an interior volume for storing a washer fluid.

8. The motor vehicle as recited in claim 7, comprising a pump that is fluidly connected to the interior volume and operable to deliver the washer fluid from the washer fluid reservoir to a camera or a sensor that is mounted within the cargo bed.

9. The motor vehicle as recited in claim 7, comprising a fluid level sensor that extends into the interior volume, wherein the fluid level sensor is configured to sense when a fluid level of the washer fluid falls below a threshold value.

10. The motor vehicle as recited in claim 4, wherein the washer fluid reservoir includes a fill neck recessed within a pocket section of the washer fluid reservoir, and further wherein the pocket section extends between the mounting flange and an upper front surface of the reservoir housing.

11. The motor vehicle as recited in claim 10, comprising a fill cap removably connected to the fill neck.

12. A washer fluid system for a motor vehicle, comprising:
a front zone including a first washer fluid reservoir configured for providing a washer fluid to a first camera or a first sensor located within the front zone; and
a rear zone including a second washer fluid reservoir configured for providing the washer fluid to a second camera or a second sensor located within the rear zone, wherein the rear zone is fluidly isolated from the front zone.

13. The washer fluid system as recited in claim 12, wherein the rear zone encompasses a cargo bed of the motor vehicle.

14. The washer fluid system as recited in claim 13, wherein the second washer fluid reservoir is mounted within a side wall of the cargo bed.

15. The washer fluid system as recited in claim 14, wherein the second washer fluid reservoir is mounted between an inner panel and an outer panel of the side wall at a location between a wheel well and a rear-most pillar of the cargo bed.

16. The washer fluid system as recited in claim 13, wherein the second camera or the second sensor is mounted within the cargo bed.

17. The washer fluid system as recited in claim 12, comprising a first hose connecting between the first washer fluid reservoir and the first camera or the first sensor, and further comprising a second, different hose connecting between the second washer fluid reservoir and the second camera or the second sensor.

18. The washer fluid system as recited in claim 12, wherein the second washer fluid reservoir includes a mounting flange, a reservoir housing, and a closeout panel.

19. The washer fluid system as recited in claim 18, wherein the closeout panel is attached to the reservoir housing to establish an interior volume for storing a portion of the washer fluid.

20. The washer fluid system as recited in claim 18, wherein the second washer fluid reservoir includes a pump and a fluid level sensor.
